(19) United States
(12) Patent Application Publication
(10) Pub. No.: US 2008/0124684 A1
(43) Pub. Date: May 29, 2008

(54) System and method of celebration by personalizing apparel

(76) Inventor: Mathew L. Grell, Norcross, GA (US)

Correspondence Address: Mathew L. Grell, 4307 Jones Bridge Circle, Norcross, GA, 30092, US

(21) Appl. No.: 11/605,922

(22) Filed: Nov. 28, 2006

(51) Int. Cl. G09B 11/04

(52) U.S. Cl. 434/81

(57) ABSTRACT

A method, system and apparatus for celebration by personalizing an item of apparel, wherein the present invention provides an invitation for selecting an article of apparel, a measuring guide, a means to decorate or personalize such article during a celebratory event in an effort to memorialize such event so as to have a tangible keepsakes or reminder of the event

### COPYRIGHT NOTICE

A portion of the disclosure of this patent document contains material which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### TECHNICAL FIELD

The present invention relates generally to a decoration system for decorating apparel and more specifically to a kit of materials allowing the participants to decorate, personalize, and celebrate an article of apparel.

### BACKGROUND

Recently, it has become increasingly popular, especially among children, to wear and display insignias, cartoon characters, words and phrases on shirts, jackets, hats and other articles of clothing to personalize such articles. This popularity has spurred the growth of a substantial industry supplying such items. In addition, craft kits for children are universally popular and enable a child having minimal skills to create objects which normally require a higher level of skill.

Kits of graphic materials, sequins, rivets, charms and the like have been provided which may be used to decorate articles of clothing. Moreover, articles of clothing are provided with preprinted indicia which may be subsequently decorated by the wearer or others to personalize such articles. In addition, fabric paints and markers are widely available today in various colors for decorating articles of clothing using screens, frames or pre-printed articles with indicia.

One of the most popular craft categories is that of “wearable art”. Wearable art includes a wide variety of designs applied to articles of clothing using a protective backing. In addition to mass-produced wearable art clothing items, there are a number of handicraft kits on the market which permit crafters to create their own wearable art clothing using pre-printed indicia articles.

Moreover, parties and other special and memorable events, such as birthdays, anniversaries, retirement parties, baby showers, wedding showers, going away parties, and the like are events that have special significance to the participants. It is a natural human desire to memorialize such events so as to have tangible keepsakes and reminders of these times. Among the common ways in which such events are memorialized are photographs, gift items, guest books, and invitation cards. Informal souvenirs often include decorated napkins, programs and the like.

However, in view of the present invention, the prior art is deficient in offering an invitation for selecting an article, a means to personalize such article during a celebration event in an effort to memorialize such event by having a personalized article of the event.

Therefore, for the foregoing reasons, it is readily apparent that there is a need for a method, system and apparatus for celebration by personalizing an item of apparel, wherein the present invention enables a convenient means for selecting an article, a means to personalizing such article, and a means for memorializing such event so as to have a tangible keepsake or reminder of the event.

### BRIEF DESCRIPTION

Briefly described, in a preferred embodiment, the present invention overcomes the above-mentioned disadvantage, and meets the recognized need for such an invention by providing a method, system and apparatus for celebration by personalizing an item of apparel, wherein the present invention provides an invitation for selecting an article of apparel, a means to personalize such article during a celebratory event in an effort to memorialize such event so as to have a tangible keepsakes or reminder of the event.

According to its major aspects and broadly stated, the present invention in its preferred form is a method, system and apparatus for celebration by personalizing an item of apparel, comprising, in general, a kit of materials for organizing a party such as a children's party or the like; for example, birthday parties. The kit includes invitations for such party, wherein an invitee is asked to select their size of an article of apparel and return such invitation R.S.V.P.; decoration materials such as fabric paints, markers, stencils, patterns, graphic materials, sequins, rivets, charms and the like allowing the participants at a party or other event or celebration to decorate an article of apparel as a keepsake to memorialize the event and personalize an article of apparel.

More specifically, the preferred embodiment of the present invention is a method, system and apparatus for celebration wherein an invitee preferably personalizes apparel, comprising the step of decorating such apparel using fabric paints, markers, stencils, patterns, graphic materials, sequins, rivets, charms and the like to personalize such footwear.

Accordingly, a feature and advantage of the present invention is its ability to provide a kit having a method of providing invitations for such party, wherein an invitee is asked to select their size of an article of apparel by selecting their size from a size chart, table or graphic.

Accordingly, a feature and advantage of the present invention is its ability to provide a kit having a method of providing invitations for such party, wherein an invitee is asked to select their size of footwear by stepping on an invitation having a footwear size chart and marking their size.

Another feature and advantage of the present invention is its ability to provide a kit having multiple colors of fabric paint and/or markers for decorating and personalizing an article of apparel.

Still another feature and advantage of the present invention is its ability to provide a kit of stencils or patterns for tracing or outlining patterns on an article of apparel to assist participants having minimal artistic skills.

Yet another feature and advantage of the present invention is its ability to provide a kit having graphic materials such as decals, stickers, stamps and the like for decorating an article of apparel.

Yet another feature and advantage of the present invention is its ability to provide a kit having sequins for decorating an article of apparel.

Yet another feature and advantage of the present invention is its ability to provide a kit having rivets for crimping into the fabric and for decorating an article of apparel.

Yet another feature and advantage of the present invention is its ability to provide a kit having charms for attaching to such article and for decorating an article of apparel.

Yet another feature and advantage of the present invention is its ability to provide a kit having decorative shoe lace eyelet for snapping into existing eyelets and for decorating an article of apparel.

Yet another feature and advantage of the present invention is its ability to provide a kit having shoe strings or laces, shoe string coilers, no tie shoe strings/laces, and other shoe fastening systems.

Yet another feature and advantage of the present invention is its ability to serve as a self motivated learning aid for the user or student, by discriminating both according to colors and shapes, by sharpening visual and positional perceptions, by developing eye/hand coordination and small motor skills, and by demanding that one follow instructions and/or act only according to some sequential manner. The designs may introduce the use of negative and positive space perspectives and the use of shapes to form the illustration.

Yet another feature and advantage of the present invention is its ability to provide a variety of kits, each illustrating a special event or theme.

Yet another feature and advantage of the present invention is its ability to provide a variety of kits, each illustrating a special event or celebration, thereby memorialize such event or celebration.

Yet another feature and advantage of the present invention is its ability to provide a variety of kits, each illustrating a special event or theme, thereby providing a stimulus for talking about the event or theme, for sharing with and helping one another in a class/community atmosphere, and for enjoying art while sharpening manual skills.

Yet another feature and advantage of the present invention is its ability to provide a kit which is inexpensive to manufacture and is safe to use, for no component of the kit is in any way hazardous or toxic.

Yet another feature and advantage of the present invention is its ability to provide a kit which allows participants to add their names or other messages to the article of apparel using fabric markers or other instruments suitable for decoration.

Yet another feature and advantage of the present invention is its ability to provide a kit which allows the participants at a special occasion to decorate an article of apparel as a keepsake of the occasion.

Yet another feature and advantage of the present invention is its ability to provide a kit for allowing users to personalize an article of apparel.

Yet another feature and advantage of the present invention is its ability to provide a kit that provides a user with a sense of accomplishment.

These and other features and advantages of the present version of the invention will become more apparent to one skilled in the art from the following description and claims when read in light of the accompanying drawings.

### BRIEF DESCRIPTION OF THE DRAWINGS

The present invention will be better understood by reading the Detailed Description of the preferred and alternate embodiments with reference to the accompanying drawing figures, in which like reference numerals denote similar structure and refer to like elements throughout, and in which:

FIG. 1 is a view of a sample invitation to a celebration according to a preferred embodiment of the present invention;

FIG. 2 is a top view of a kit according to a preferred embodiment of the present invention;

FIG. 3 schematically illustrates the components which make up a kit according to a preferred embodiment of the present invention; and

FIG. 4 is a perspective view of a shoe utilizing the apparel decorating kit according to a preferred embodiment of the present invention.

### DETAILED DESCRIPTION OF THE PREFERRED AND ALTERNATIVE EMBODIMENTS

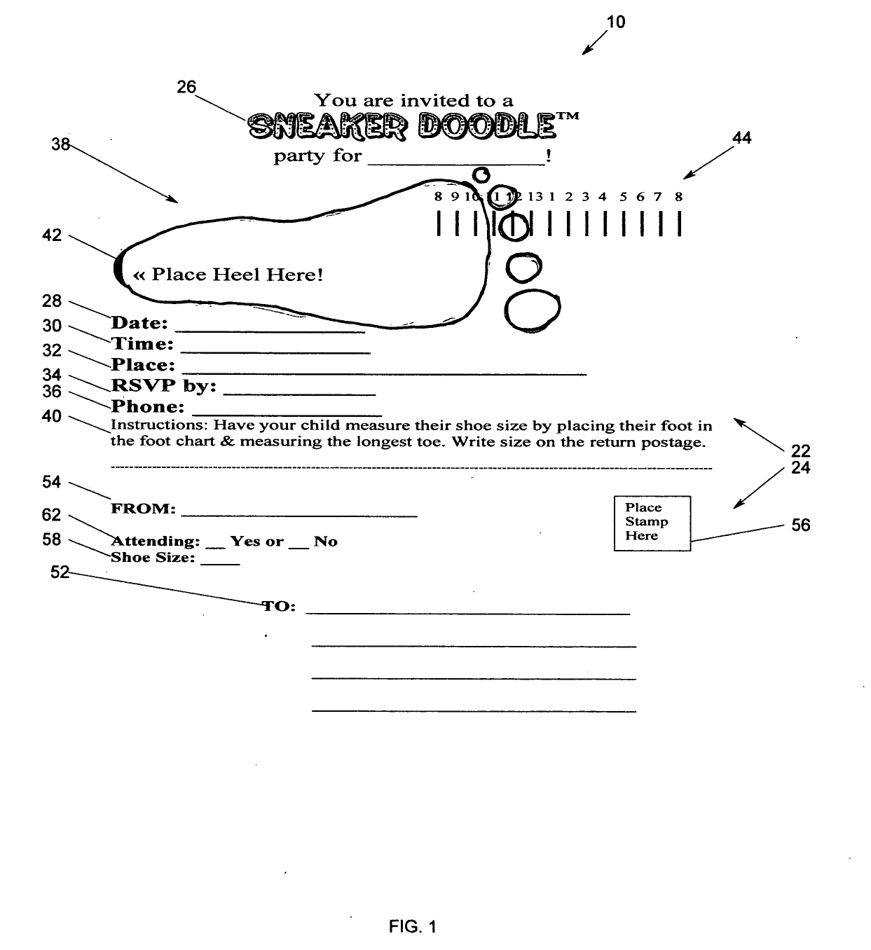

In describing the preferred and selected alternate embodiments of the present invention, as illustrated in FIGS. 1-4, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIG. 1, by way of example, and not limitation, there is illustrated a sample invitation 10. Preferably, invitation 10 is formed of a suitable paper stock capable of being printed and folded as well as other beneficial characteristic understood by one skilled in the art. Invitation 10 preferably is preprinted with an announcement portion 22 and a removable return receipt portion 24; however, invitation 10 may alternatively include two separate portions as announcement portion 22 and return receipt portion 24. Announcement portion 22 preferably includes preprinted text and fill-in the blank sections of celebration title 26, celebration date 28, celebration time 30, celebration location 32, celebration response date 34, contact information 36, apparel measurement guide 38, and instructions 40. Celebration title 26 preferably includes preprinted text and fill-in the blank “You are invited to a SNEAKER DOODLE™ Party for ______!” however, in the alternative other celebration titles are contemplated herein including, but not limited to, titles for birthdays, anniversaries, retirement parties, baby showers, wedding showers, going away parties, special events or themes and the like. Further, celebration title 26 enables the celebration organizer to identify the person(s) who is/are the subject of the celebration (guest of honor) and whether such celebration is a surprise celebration for such guest of honor. Celebration date 28 preferably includes preprinted text and fill-in the blank “Date: ______” enabling the celebration organizer to specify the date of the celebration. Celebration time 30 preferably includes preprinted text and fill-in the blank “Time: ______” enabling the celebration organizer to specify the time of the celebration on such celebration date. Celebration location 32 preferably includes preprinted text and fill-in the blank “Place: ______” enabling the celebration organizer to specify the location of the celebration. Celebration response date 34 preferably includes preprinted text and fill-in the blank “R.S.V.P. by: ______” enabling the celebration organizer to specify a date when return receipt portion 24 should be returned. Contact information 36 preferably includes preprinted text and fill-in the blank “Phone: ______” enabling the celebration organizer to provide a means for the invitee to contact the celebration organizer; however, in the alternative other contact information is contemplated herein including, but not limited to, email, mobile, fax, home and office phone numbers, and the like.

Apparel measurement guide 38 preferably includes heel mark 42 and size indicator 44 enabling a user of apparel measurement guide to measure their current shoe size. Heel mark 42 preferably includes a half-circle mark and text “Place Heel Here.” Size indicator 44 preferably includes US kid's size markings “8, 9, 10, 11, 12, 13, 1, 2, 3, 4, 5, 6, 7, and 8.” However, it is contemplated herein that size indicator 44 may include kid's, children's, men's, women's, US, Europe, United Kingdom, international, inches, centimeters size or conversion information. Instructions 40 preferably includes text “Instructions: Have your child measure their shoe size by placing their foot in the foot chart & measuring the longest toe and write size on the return postage” on return receipt portion 24. Instructions 40 alternatively may include text “Place your heel on the chart where indicated and measure to the end of your longest toe. If the toe is in between sizes, this indicates a half size” or other text applicable for measuring apparel item A.

It is contemplated herein that announcement portion 22 may include any style of text, font or graphic may be utilized to create invitation 10 and that such fill in the blank entries may be preprinted.

Although the foregoing describes the preferred announcement selections for announcement portion 22, it is recognized that other announcement criteria, text, font or graphic may be printed on announcement portion 22. Furthermore, apparel measurement guide 38 may be configured depending on the specific apparel item selected utilizing a grid, chart, table, graphic or the like, including but not limited to measurement guides for shoes, sneakers, boots, shirts, shorts, skirts, pants, coats, belts, leggings, socks, hats, gloves, scarf, handbags, wallets, glasses, pillow cases, sheets, towels, pet accessories or the like (apparel item A).

Return receipt portion 24 preferably includes preprinted text and fill-in the blank sections of mailing address 52, return address 54, postage 56, apparel size 58 and confirmation notice 62. Mailing address 52 preferably includes preprinted text and fill-in the blank “TO: ______” enabling the celebration organizer to enter their name and return address on return receipt portion 24. Return address 54 preferably includes preprinted text and fill-in the blank “FROM: ______” enabling the invitee or celebration organizer to enter their name and return address on return receipt portion 24. Postage 56 preferably includes preprinted text and fill-in the blank “Place Stamp Here” indicating position of postage stamp on return receipt portion 24. Apparel size 58 preferably includes preprinted text and fill-in the blank “Size: ______” enabling the invitee to enter their apparel size preferably determined utilizing apparel measurement guides 38 of announcement portion 22. Moreover, apparel size 58 may include, but is not limited to, measurement guides for apparel item A. Confirmation notice 62 preferably includes preprinted text and fill-in the blank “Attending ______ Yes or ______ No” enabling the invitee to confirm whether or not invitee will be attending the celebration.

It is contemplated herein that return receipt portion 24 may include any style of text, font or graphic may be utilized to create invitation 10 and that such fill in the blank entries may be preprinted. Although the foregoing describes the preferred announcement selections for return receipt portion 24, it is recognized that other announcement criteria, text, font, or graphic may be printed on return receipt portion 24.

In use celebration organizer fills in the fill-in the blank sections of invitation 10 for details of the event preferably celebration title 26, celebration date 28, celebration time 30, celebration location 32, celebration response date 34, contact information 36 of announcement portion 22, mailing address 52, and adheres the correct return postage stamp to location postage 56, and mails invitation 10 to invitees. Upon receiving invitation 10, invitee fills in the fill-in the blank sections of invitation 10 preferably return address 54, apparel size 58, and confirmation notice 62. Invitee preferably utilizes apparel measurement guide 38 of invitation 10 to determine invitee's apparel size and fills in the fill-in the blank section of apparel size 58 of return receipt portion 24. Next, invitee preferably removes return receipt portion 24 from announcement portion 22 keeping announcement portion 22 as a reminder of the celebration and mails return receipt portion 24 back to celebration organizer. It is contemplated herein that invitee alternatively may telephone, email or use other forms of communication to deliver apparel size 58 and whether or not invitee will be attending the celebration, confirmation notice 62.

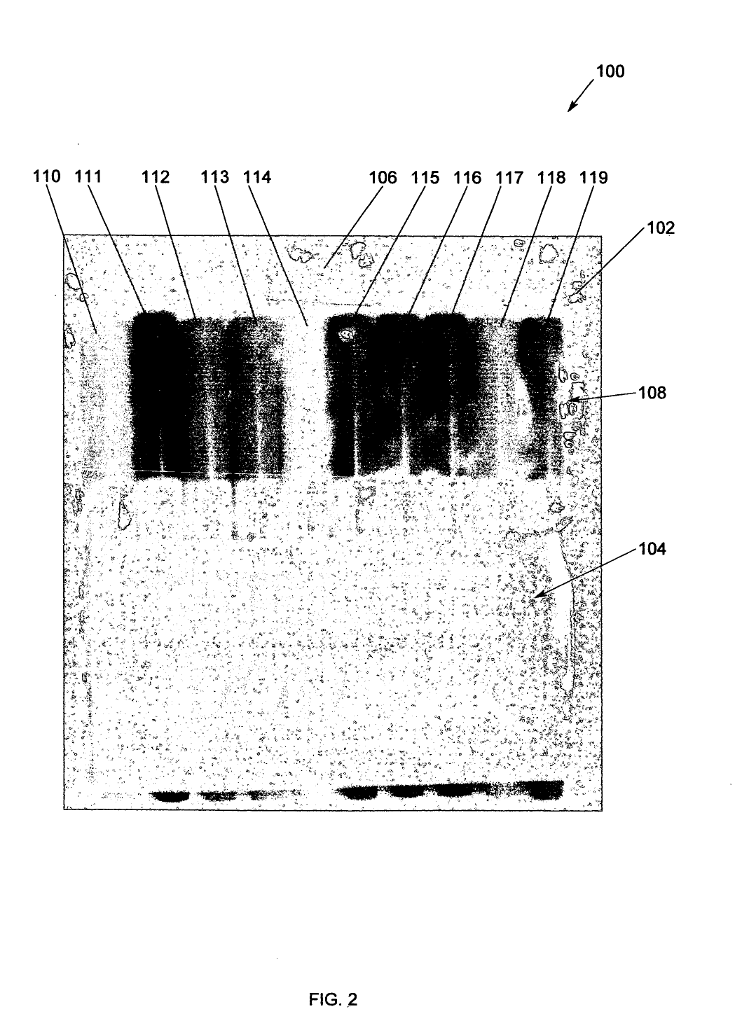

Referring now to FIG. 2, by way of example, and not limitation, there is illustrated an apparel decorating kit 100. Preferably, kit 100 is contained in a clear plastic case 102 with marketing emblem 104, wherein such case is utilized to visually displaying the contents of kit 100. Alternatively, kit 100 may be displayed in a blister card having a cardboard backing with a clear plastic cover encapsulating kit 100 or other packaging system understood by one skilled in the art and capable of housing a variety of apparel decorating articles and/or systems. Either packaging option preferably includes hanger cut out 106 enabling kit 100 to be displayed for sale preferably on a hook, hand tag or other display mechanism and preferably in close proximity to apparel item A. Marketing emblem 104 is preferably inserted in case 102 to identify and advertise the purpose, potential uses and contents of kit 100; however, in the alternative marketing emblem 104 may be adhered or screened onto case 102. Preferably, displayed in case 102 are ten markers 108 including pink marker 110, black marker 111, red marker 112, light blue marker 113, yellow marker 114, brown marker 115, deep blue marker 116, green marker 117, orange marker 118, and purple marker 119. Markers 108 preferably include fabric markers designed to color fabric with permanent ink; however, washable markers are contemplated herein enabling the artist to wash the markers from their skin, most clothing and household surfaces. Furthermore, washable markers may enable the user of kit 100 to start with a clean apparel item A to be re-decorated after a regular laundering of such apparel item A. Preferably, markers 108 are capable of marking most fabrics including but not limited to cotton, canvas, nylon, polyester, leather, denim, wool, silk, linen, velvet, flock, faux leather, faux suede, burlap, plastic, rubber and the like as well as blends of these fabrics. Markers 108 may be provided with any variety of ink colors, including gel based inks, and with or without metallic particles and the like as well as marker point sizes or combination point sizes ranging from fine point, round point, chisel point and the like. It should be recognized that kit 100 may include any style of marking device made commercially available. Moreover, it is contemplated that markers 108 may include paint with brush, roller or the like, spray paint, crayon, glue and glitter and other marking systems understood by one skilled in the art.

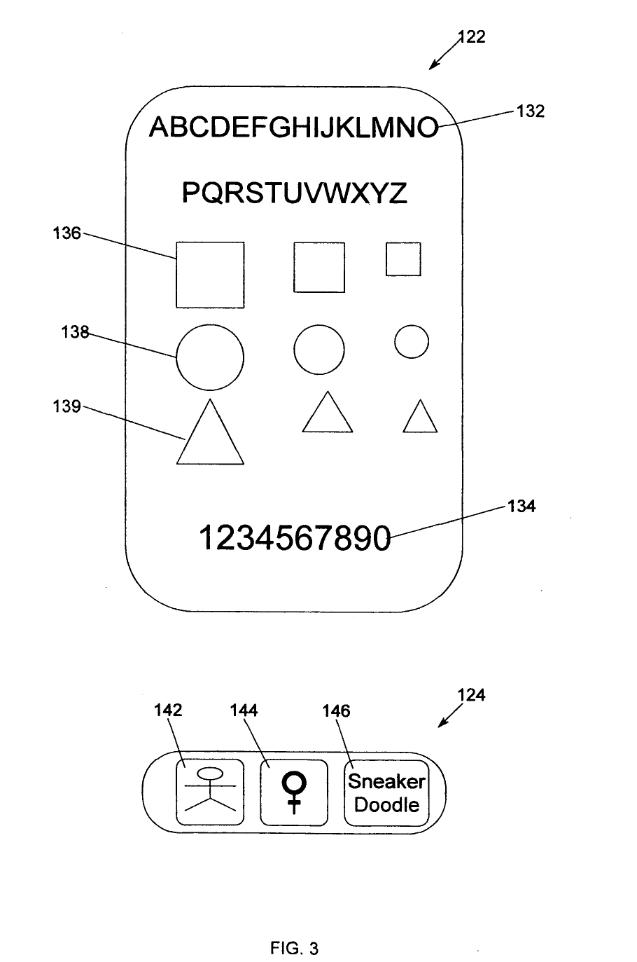

Referring now to FIG. 3, by way of example, and not limitation, there is illustrated schematically several article components which make up kit 100. Preferably kit 100 includes invitation(s) 10 (shown in FIG. 1), marker(s) 108 (shown in FIG. 2), and may include anyone or more of the following articles set forth in FIG. 3, including but not limited to stencil(s) 122, stickers 124, charms 126, rivets 128 and the like or any combination of such articles. Stencil 122 is preferably formed of a suitable material, such as mylar, plastic, metal, cardboard, rubber, foam, paper or the like, capable of providing structure to stencil 122. Preferably, the material includes other suitable characteristics, such as durability, water-resistance, light weight, chemical inertness, ease of workability, or other beneficial characteristic understood by one skilled in the art. Preferably, stencil 122 includes cutouts in such material to enable an artist to produce a theoretically identical reproduction of the cutout image on apparel item A. Stencil 122 preferably is formed by cutting or removing sections from template material in the form of text or an image. This creates what is essentially a physical negative of the text or image. Stencil 122 preferably is placed on apparel item A and utilized to create impressions of the stenciled image, by applying marker(s) 108 through the removed sections of stencil 122, leaving a reproduction of the stencil image or text on the underlying surface of apparel item A. Moreover, the images produced using stencil 122 may be based on messy free form designs so as to allow for illustration imperfections or errors when transferring or drawing the image on apparel item A. Stencil 122 includes the English alphabet 132, numbers 134, and standard shapes such as square 136, circle 138 and triangle 139; however, other text, quotations, popular statements or images, patterns, language symbols, images, characters and sets of images or characters as well as theme images are contemplated by this invention such as planets and stars, tropical settings and other environments, animals, insects, plants, dinosaurs, buildings, structures, cartoon characters, and the like (image(s)). Moreover, stencil 122 may include a peel and stick stencil that has an adhesive under a peel off protective coating to adhere stencil 122 to apparel item A securing stencil 122 to apparel item A while an artist stencils images onto apparel item A.

Stickers 124 preferably are formed of a suitable substrate, such as plastic, rubber, foam, or the like, capable of providing a medium to affix text or an image or any combination of the two on one side and an adhesive on the other side. Stickers 124 preferably include a peel and stick sticker that has an adhesive under a peel off protective layer to adhere stickers 124 to apparel item A by removing such peel off protective layer and positioning sticker 124 on apparel item A and firmly pressing it to such item. Stickers 124 includes symbol of a person 142, symbol of a woman 144, and text Sneaker Doodle 146; however similar to stencil 122, stickers 124 are available in a variety of text, images and any combinations of the two.

Charms 126 are preferably formed of a suitable material, such as plastic, metal, precious metals, rubber, foam or the like, capable of providing structure and form to charm 126. Preferably charms 126 are cast in a variety of shapes, sizes and images and have a means to attach charms 126 to apparel item A understood by one skilled in the art.

Rivets 128 are preferably formed of a suitable material, such as plastic, metal, precious metals, rubber, foam or the like; capable of providing structure and form to rivets 128. Preferably rivets 128 are cast in a variety of shapes, sizes and images and have a means to attach rivets 128 to apparel item A such as tangs, which in use pierce apparel item A and are up-turned or bent over on the other side of apparel item A, in order to affix rivets 128 to apparel item A or other attachment elements or anchor understood by one skilled in the art. Moreover, rivets 128 may include reflective surfaces, sequins, artificial stones, Rhine stones and the like.

It is further contemplated herein that kit 100 may include glue or other similar adhesive (capable of adhering rivets 128, charms 126) in conjunction with glitter, glitter spray, glitter gel, sparkles, sequins, powders, flakes, crystals and the like utilized to decorate or personalize apparel item A. Moreover, glitter and the like may be used in conjunction with stencils 122.

It is further contemplated herein that kit 100 may include stamps and ink pads wherein stamps include an assortment of text, graphics, quotations, statements and images or any combination of the same. In use an artist inks the stamp by pressing it into the ink pad and then applies or prints the stamp on apparel item A.

It is further contemplated herein that kit 100 may include shoe strings or laces, shoe string coilers, no tie shoe strings/laces, and other shoe fastening systems.

It is further contemplated herein that kit 100 may include snap in shoe string or lace eyelets formed of a suitable material, such as plastic, metal or the like, capable of providing structure and form, and available in a variety of shapes, sizes and colors.

It is further contemplated herein that kit 100 may include any other party accessory such as balloons, hats, noise makers, string, and the like.

It is still further contemplated herein that kit 100 may include instructions for decorating apparel item A utilizing marker(s) 108, stencil(s) 122, stickers 124, charms 126, rivets 128, string or lace eyelets, shoe strings or laces, shoe string coilers, no tie shoe strings/laces and the like or any combination of the same, including suggestions of where to place stencil(s) 122 for marking, color choices, and suggestions of where to place stickers 124, charms 126, rivets 128, string or lace eyelets, shoe strings or laces, shoe string coilers, no tie shoe strings/laces and the like on apparel item A. Such instructions may be printed on the back of such blister card or as an insert in the clear plastic case.

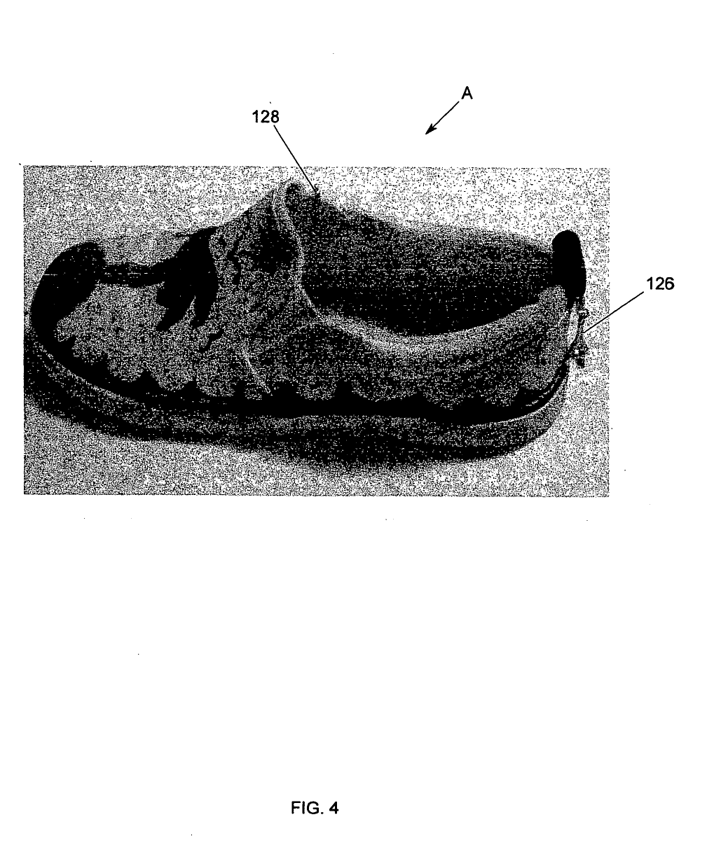

Referring now to FIG. 4, by way of example, and not limitation, there is illustrated a perspective view of an apparel item decorated utilizing apparel decorating kit 100. Apparel item A preferably is a canvas or other fabric shoe or sneaker capable of decorating by personalizing apparel item A utilizing or applying marker(s) 108, stencil(s) 122, stickers 124, charms 126, rivets 128, string or lace eyelets, shoe strings or laces, shoe string coilers, no tie shoe strings/laces and the like or any combination of the same to such footwear. By utilizing apparel decorating kit 100 an artist may create a personalized apparel items A by free hand drawing an illustration such as the waves, island, palm tree, birds, and sun 132 (shown in FIG. 4) drawn on apparel item A or utilizing marker(s) 108, stencil(s) 122, stickers 124, charms 126, rivets 128, string or lace eyelets, shoe strings or laces, shoe string coilers, no tie shoe strings/laces and the like or any combination of the same to personalize such apparel item A as a keepsake to memorialize such event or celebration so as to have a tangible keepsake or reminder of the event. It is further contemplated herein that other illustrations other than illustration 132 are considered to be within the scope of the present invention and may be set forth in stencil 122.

With reference now to FIGS. 1-4, a method for organizing a party or other special or memorable event or occasion, such as birthdays, anniversaries, retirement parties, baby showers, wedding showers, going away parties and the like will be described. First, celebration organizer fills in the fill-in the blank sections of invitation 10 preferably celebration title 26, celebration date 28, celebration time 30, celebration location 32, celebration response date 34, contact information 36 of announcement portion 22, mailing address 52, and adheres the correct return postage stamp to location postage 56, and mails invitation 10 to invitees. Next, upon receiving invitation 10, invitee fills in the fill-in the blank sections of invitation 10 preferably return address 54, apparel size 58, and confirmation notice 62. Invitee preferably utilizes apparel measurement guide 38 of invitation 10 to determine invitee's apparel size and fills in the fill-in the blank section of apparel size 58 of return receipt portion 24. More specifically, invitee preferably places his or her foot on apparel measurement guide 38 shown in announcement portion 22 and determines their shoe size by reading the diagram markings. If a foot falls on a line then a half size should be added for the correct shoe size. Next, invitee preferably removes return receipt portion 24 from announcement portion 22 keeping announcement portion 22 as a reminder of the celebration and mails return receipt portion 24 back to celebration organizer.

Next, celebration organizer obtains the selected sizes of apparel items A for each invitee and an adequate number of apparel decorating kits 100 for the celebration event. Next, each attendee to the celebration is provided with apparel item A and access to apparel decorating kit 100 during the celebration. Next, each attendee personalizes their selected size of apparel item A as a keepsake to memorialize such event or celebration so as to have a tangible keepsakes or reminder of the event.

It is further contemplated herein that attendees may align, press or adhere stencil(s) 122 to apparel item A to aid the attendee in transferring/marking the illustration set forth in stencil(s) 122 onto apparel item A utilizing marker(s) 108.

It is still further contemplated herein that attendee may affix stickers 124, charms 126, rivets 128, string or lace eyelets, shoe strings or laces, shoe string coilers, no tie shoe strings/laces and the like or any combination of the same to apparel item A.

It is still further contemplated herein that attendees may personalize an apparel item A as a keepsake to memorialize such event or celebration for the quest of honor so that the guest of honor has a tangible keepsakes or reminder of the event or celebration.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims and their legal equivalents.

What is claimed is:

1. A kit for use by an event organizer and participants for decorating an article of apparel to create a personalized keepsake of the event, comprising:
an invitation for inviting participants, wherein said invitation comprises an apparel measurement guide for assisting the participant with determining a size of the article of apparel; and
at least one marker means for decorating the article of apparel.

2. The kit of claim 1 wherein said invitation further comprises an announcement portion for inviting participants to the event.

3. The kit of claim 1 wherein said invitation further comprises a return receipt portion for confirming attendance to the event.

4. The kit of claim 1 wherein said invitation further comprises a return receipt portion for specifying said size of the article of apparel.

5. The kit of claim 1 wherein said apparel measurement guide further comprises a shoe measuring guide.

6. The kit of claim 1 wherein said invitation further comprises fill-in the blank sections for specifying details of the event.

7. The kit of claim 1 further comprising a case for displaying the contents of said kit.

8. The kit of claim 1 wherein said marker means includes permanent ink fabric markers in an assortment of colors.

9. The kit of claim 1 wherein said marker means includes washable ink fabric markers in an assortment of colors.

10. The kit of claim 1 further comprising at least one stencil.

11. The kit of claim 10, wherein said marker is utilized to trace a cutout in said stencil on the article of apparel.

12. The kit of claim 10, wherein said stencil comprises means for decorating the article of apparel.

13. The kit of claim 10, wherein said stencil comprises means for reproducing a stencil image on the underlying article of apparel.

14. The kit of claim 1 further comprising at least one sticker.

15. The kit of claim 14, wherein said sticker is adhered to the article of apparel.

16. The kit of claim 14, wherein said sticker comprises means for decorating the article of apparel.

17. The kit of claim 1 further comprising at least one charm.

18. The kit of claim 17, wherein said charm is attached to the article of apparel.

19. The kit of claim 17, wherein said charm comprises means for decorating the article of apparel.

20. The kit of claim 1 further comprising at least one rivet.

21. The kit of claim 20, wherein said rivet is affixed to the article of apparel.

22. The kit of claim 20, wherein said rivet comprises means for decorating the article of apparel.

23. The kit of claim 1 further comprising at least one stamp.

24. The kit of claim 23, wherein said stamp is printed on the article of apparel.

25. The kit of claim 23, wherein said stamp comprises means for decorating the article of apparel.

26. The kit of claim 1 further comprising a set of shoe laces.

27. The kit of claim 1 further comprising a set of shoe string coilers.

28. The kit of claim 1 further comprising a snap in shoe lace eyelet.

29. The kit of claim 11 wherein said kit further comprises means for decorating the article of apparel.

30. The kit of claim 1, wherein said kit further comprises means for personalizing the article of apparel.

31. The kit of claim 1, wherein said kit further comprises means for developing eye-hand coordination.

32. The kit of claim 1, wherein said kit further comprises means for developing negative and positive space perspectives.

33. A kit for decorating an article of apparel, comprising:
at least one marker;
at least one stencil; and
wherein said stencil and said marker comprises means for decorating the article of apparel.

34. The kit of claim 33 further comprising a case for displaying the contents of said kit.

35. The kit of claim 33 wherein said marker includes permanent ink fabric markers in an assortment of colors.

36. The kit of claim 33 wherein said marker includes washable ink fabric markers in an assortment of colors.

37. The kit of claim 33, wherein said marker is utilized to trace a cutout in said stencil on the article of apparel.

38. The kit of claim 33, wherein said stencil comprises means for reproducing a stencil image on the underlying article of apparel.

39. A method of producing a keepsake article of apparel commemorating a memorable occasion, comprising the steps of:
sending an invitation to the participant, wherein said invitation comprises an apparel measurement guide;
utilizing said apparel measurement guide to determine a size of the article of apparel for such participant; and
returning a receipt portion of said invitation with said size of the article of apparel to a celebration organizer.

40. The method of claim 39, further comprising the step of decorating said article of apparel producing a keepsake article of apparel commemorating the memorable occasion.

41. The method of claim 39, further comprising the step of personalizing said article of apparel producing a keepsake article of apparel commemorating the memorable occasion.

43. The method of claim 39, wherein said invitation further comprises the step of filling in the blank sections of said invitation specifying details of the occasion.

44. The method of claim 40, wherein said decorating step further comprises the step of reproducing a stencil image on the underlying article of apparel.

45. The method of claim 40, wherein said decorating step further comprises the step of adhering at least one sticker to the article of apparel.

46. The method of claim 40, wherein said decorating step further comprises the step of attaching at least one charm to the article of apparel.

47. The method of claim 40, wherein said decorating step further comprises the step of affixing at least one rivet to the article of apparel.

48. The method of claim 40, wherein said decorating step further comprises the step of printing at least one stamp on the article of apparel.

49. The method of claim 40, wherein said decorating step further comprises the step of marking the article of apparel.
